(19) United States
(12) Patent Application Publication
(10) Pub. No.: US 2013/0333906 A1
(43) Pub. Date: Dec. 19, 2013

(54) Machine Tool and Control Method

(71) Applicant: Hilti Aktiengesellschaft, Schaan (LI)

(72) Inventor: Albert Binder, Buchs (CH)

(21) Appl. No.: 13/918,462

(22) Filed: Jun. 14, 2013

(30) Foreign Application Priority Data
Jun. 15, 2012 (DE) 102012210096.2

(51) Int. Cl. B25D 11/06

(52) U.S. Cl. CPC B25D 11/064
USPC 173/2; 173/1

(57) ABSTRACT

A machine tool with a tool holder equipped to mount a chiseling tool moveably along a movement axis. A magnetic-pneumatic striking mechanism contains a primary drive arranged around the movement axis. The primary drive includes a first magnetic coil and a second magnetic coil in sequence in the impact direction. The striking mechanism has, in sequence, a striker and an anvil arranged within the magnetic coils on the movement axis in the impact direction. In addition, the striking mechanism has an air spring affecting the striker in the impact direction. A controller is configured to activate the primary drive during an active retraction phase to accelerate the striker opposite the impact direction until a kinetic energy of the striker is sufficient to achieve a selected compression of the air spring as a function of the impact energy of the striker.

### CROSS-REFERENCE TO RELATED APPLICATIONS

The present application claims priority to German Patent Application No. DE 10 2012 210 096.2, filed Jun. 15, 2012, which is hereby incorporated by reference herein in its entirety.

### BACKGROUND

The present technology relates to a machine tool which can drive a chiseling tool. A striker is accelerated directly by magnetic coils and impacts the tool. Machine tools of this type are generally known, for example, from publication US 2010/0206593.

### BRIEF SUMMARY

Certain embodiments of the present technology relate to a machine tool having a tool holder equipped to mount a tool, such as a chiseling tool, moveably along a movement axis. A magnetic-pneumatic striking mechanism contains a primary drive which has, arranged around the movement axis, at least one magnetic coil. In some embodiments, the primary drive includes a first magnetic coil and a second magnetic coil in sequence in the impact direction. The striking mechanism has a striker and an anvil in sequence in the impact direction within the magnetic coil(s) on the movement axis. In addition, the striking mechanism may include an air spring affecting the striker in the impact direction. A controller is configured to activate the primary drive during an active retraction phase to accelerate the striker opposite the impact direction until a kinetic energy of the striker is sufficient to achieve a selected compression of the air spring as a function of the impact energy of the striker. In some embodiments, the controller is further configured to deactivate the primary drive during a resting phase following the active retraction phase up until achieving the selected compression of the air spring. In some embodiments the controller is further configured to activate the primary drive following the resting phase to accelerate the striker in the impact direction.

Certain embodiments of the present technology relate to a control method for a machine tool that includes a tool holder and a magnetic-pneumatic striking mechanism. The tool holder is equipped to mount a tool, such as a chiseling tool, moveably along a movement axis. The magnetic-pneumatic striking mechanism includes a primary drive, a striker, an anvil and an air spring. The primary drive is arranged around the movement axis and includes, in sequence in an impact direction, a first magnetic coil, a permanent and radially magnetized annular magnet, and a second magnetic coil. The striker and anvil are movable within the magnetic coils on the movement axis in sequence in the impact direction, and the air spring affects the striker in the impact direction. The control method includes activating the primary drive during an active retraction phase to accelerate the striker opposite the impact direction until a kinetic energy of the striker is sufficient to achieve a selected compression of the air spring as a function of the impact energy of the striker. According to some embodiments, the method may further include deactivating the primary drive during a resting phase, following the active retraction phase up until achieving the selected compression of the air spring, and activating the primary drive following the resting phase to accelerate the striker in the impact direction.

According to some embodiments, the primary drive can be deactivated before the desired compression is achieved. In this regard, the striker can further significantly compress the air spring due to the momentum of the striker even after switching off or reducing power to the primary drive. In some embodiments, the kinetic energy of the striker upon switching off may, for example, be in the range of at least 70% of the potential energy of the compressed air spring to be achieved.

Some embodiments may include a resting phase, in which the primary drive is deactivated, following the active retraction phase and up until achieving the selected compression of the air spring. Deactivation of the primary drive may be advantageous in increasing the efficiency of the striking mechanism. This is because the efficiency of the primary drive decreases at increasing compression of the air spring because the striker increasingly overlaps completely with the first magnetic coil. In some embodiments, the duration of the resting phase may, for example, less than 10% of the duration of the active retraction phase.

According to some embodiments, a potential energy of the air spring at the selected compression may be on the order of between 25% and 40% of the impact energy of the striker. With regard to the structures of the striking mechanism tested, a higher potential energy of the air spring proved to be surprisingly disadvantageous up to a decreasing impact energy. This is because the striker may project almost completely into the second magnetic coil before the coil can establish a magnetic field due to the high inductivity thereof. When this occurs, the primary drive may no longer be able to significantly accelerate the striker.

According to some embodiments, during the active retraction phase, the method may estimate an achievable compression of the air spring without assistance from the primary drive. According to some embodiments, the method determines the achievable compression of the air spring on the basis of a measurement of the current pressure in the air spring, for example. In addition, in some embodiments the method determines the achievable compression of the air spring on the basis of a measurement of the current velocity of the striker. In some embodiments, the method may determine the measurement of the current velocity of the striker on the basis of a gradient of the measurement of the current pressure in the air spring, for example. In some embodiments, the method may identify an achievable compression on the basis of the measurement of the current pressure and/or the measurement of the velocity from a reference table.

In some embodiments, the machine tool has a permanent and radially magnetized annular magnet, e.g., made of a plurality of permanent magnets, between the first magnetic coil and the second magnetic coil along the impact direction. A control method regulates current in the magnetic coils. During the active retraction phase, a first magnetic field is generated inside of the first magnetic coil by the first magnetic coil which is constructively superposed with the magnetic field of the annular magnet and a second magnetic field generated inside of the second magnetic coil by the second magnetic coil is destructively superposed with the magnetic field of the annular magnet. During the resting phase, the first magnetic coil and the second magnetic coil do not generate a magnetic field. The gradient of the magnetic field strength between the region inside the first magnetic coil and the region inside the second magnetic coil exerts a reluctance force on the striker.

At least one embodiment provides that, during the active retraction phase, a power source supplies a current in the same circumferential direction into the first magnetic coil and into the second magnetic coil, and the power source does not supply current into the magnetic coils during the resting phase.

At least one embodiment provides that an evaluation device detects a change in pressure in the air spring during the resting phase and, at a drop in pressure, triggers a beginning of an acceleration phase, wherein the primary drive accelerates the striker in the impact direction during the acceleration phase.

At least one embodiment provides that a first magnetic field generated inside of the first magnetic coil by the first magnetic coil is destructively superposed with the magnetic field of the annular magnet during the acceleration phase and a second magnetic field generated inside of the second magnetic coil by the second magnetic coil is constructively superposed with the magnetic field of the annular magnet during the acceleration phase.

### BRIEF DESCRIPTION OF THE DRAWINGS

FIG. 1 is an electric chisel according to certain embodiments of the present technology.

FIG. 2 is a striking mechanism of the electric chisel.

FIG. 3 is a movement of the striker and anvil.

FIG. 4 is a cross-section through the striking mechanism in plane Iv-Iv.

FIG. 5 is an electrical schematic of the striking mechanism.

FIG. 6 is a control diagram.

Similar or functionally similar elements are indicated using the same reference signs in the figures, insofar as nothing otherwise is indicated.

### DETAILED DESCRIPTION

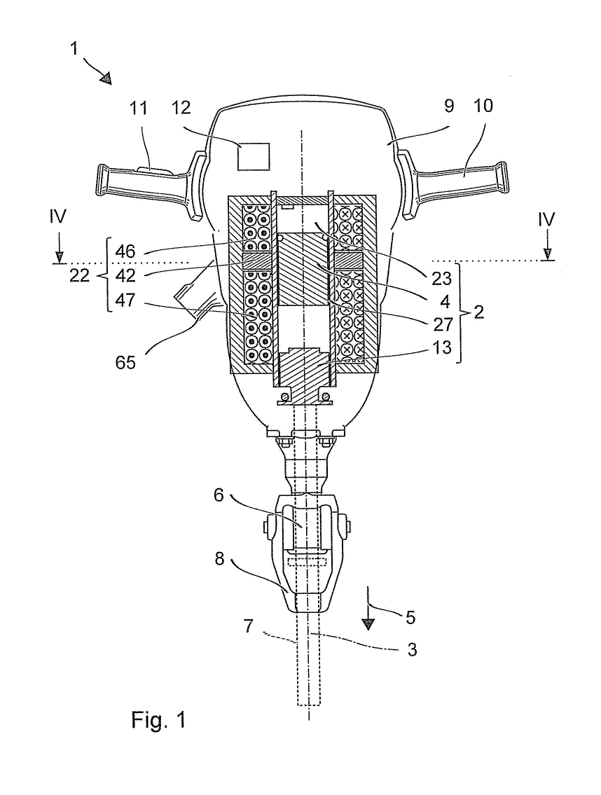

FIG. 1 shows a hand-held electric chisel 1 according to certain aspects of the present technology. A magnetic-pneumatic striking mechanism 2 generates cyclic or acyclic impacts in an impact direction 5 by means of a striker 4 guided on a movement axis 3. A tool holder 6 holds a chisel tool 7 adjacent to the striking mechanism 2 on the movement axis 3. The chisel tool 7 is moveably guided in the tool holder 6 along the movement axis 3 and can penetrate into, e.g., a subsurface in the impact direction 5 driven by the impacts. A locking mechanism 8 limits the axial movement of the chisel tool 7 in the tool holder 6. The locking mechanism 8 may, for example, be a pivotable bracket that is manually unlockable without aids to facilitate exchange of the chisel tool 7.

The striking mechanism 2 is arranged in a machine housing 9. A handgrip 10 attached to the machine housing 9 enables the user to hold the electric chisel 1 and guide the same during operation. A system switch 11, by means of which the user can start up the striking mechanism 2, may, for example, be mounted on the handgrip 10. The system switch 11 activates, for example, a controller 12 of the striking mechanism 2.

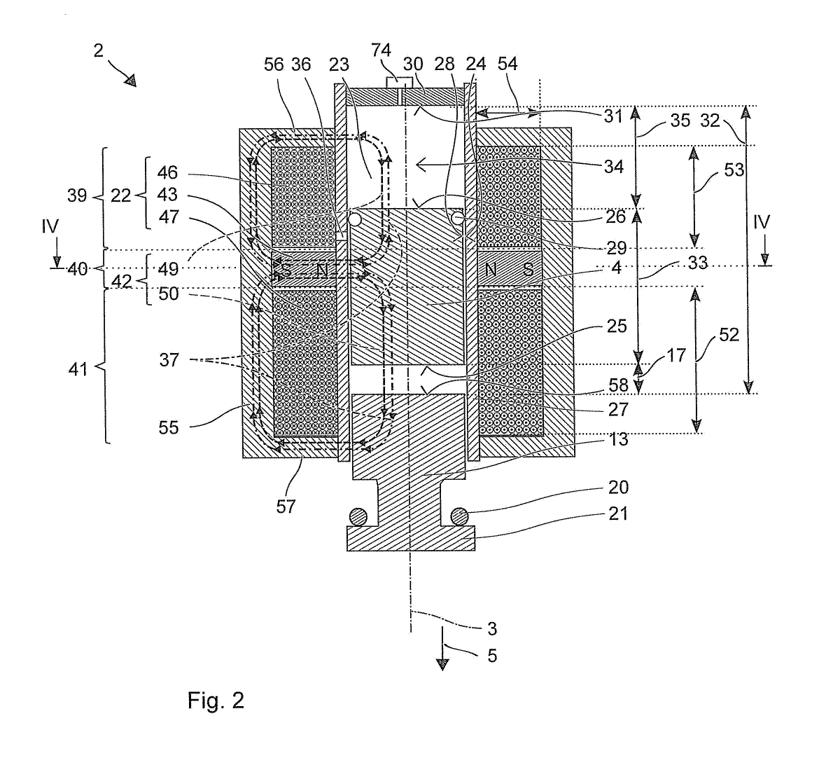

FIG. 2 shows the magnetic-pneumatic striking mechanism 2 in a longitudinal section view. The striking mechanism 2 has only two moving components: a striker 4 and an anvil 13. The striker 4 and the anvil 13 lie on the common movement axis 3; the anvil 13 follows the striker 4 in the impact direction 5. The striker 4 is moved back and forth on the movement axis 3 between an impact point 14 and an upper reversal point 15.

The striker 4 impacts the anvil 13 at the impact point 14. The position of the impact point 14 along the axis is predetermined by the anvil 13. According to some embodiments, the anvil 13 rests in a home position 16 and returns after each impact into the home position 16 before the striker 4 impacts a next time on the anvil 13. This pattern of operation is assumed for the subsequent description. However, in opposition to a conventional pneumatic striking mechanism 2, the magnetic-pneumatic striking mechanism 2 has a high tolerance regarding the actual position of the anvil 13. The anvil can even be disengaged, with respect to the home position 16, in the impact direction 5 by an impact. The home position 16 thus indicates the earliest position along the impact direction 5 at which the striker 4 can impact on the anvil 13.

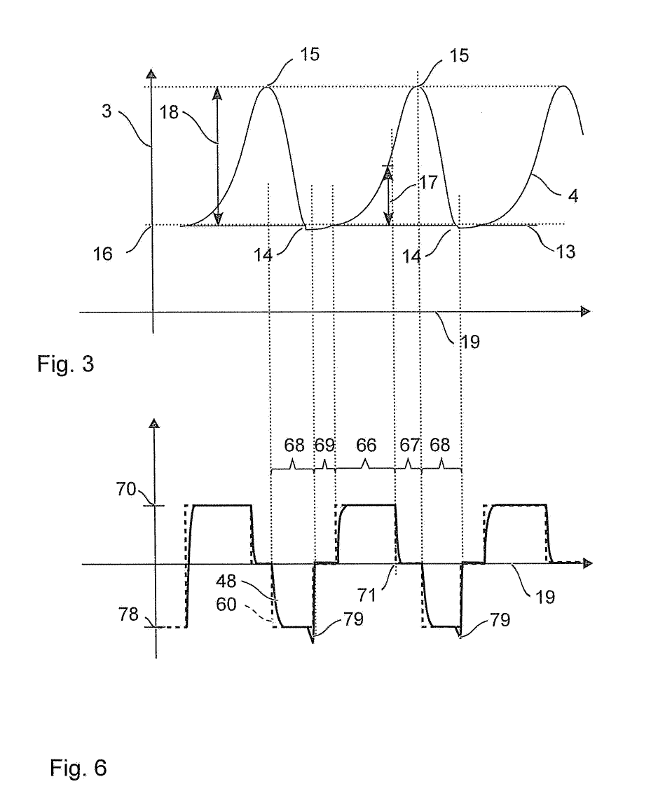

The distance 17 of the striker 4 to the anvil 13 is greatest at the upper reversal point 15; a distance thereby covered by the striker 4 is subsequently designated as stroke 18. FIG. 3 schematically illustrates the movement of the striker 4 and the anvil 13 during three subsequent impacts over time 19.

The striker 4 typically contacts the anvil 13 in the resting position thereof. For an impact, the striker 4 is moved back opposite the impact direction 5 and, after reaching the upper reversal point 15, accelerated in the impact direction 5. The striker 4 collides at the end of the movement thereof in the impact direction 5 on the anvil 13 at the impact point 14. The anvil 13 accepts significantly more than half of the kinetic energy from the striker 4 and is deflected in the impact direction 5. The anvil 13 shoves the chisel tool 7 adjacent thereto in front of itself into the subsurface in the impact direction 5. The user presses the striking mechanism 2 against the subsurface in the impact direction 5, by which means the anvil 13, e.g., indirectly by the chisel tool 7, is shoved back into the home position 16 thereof. In the home position, the anvil 13 contacts a block 20 fixed to the housing in the impact direction 5. The block 20 can, for example, contain a damping element. The exemplary anvil 13 has radially protruding flanks 21, which can contact the block 20.

The striker 4 is driven contact-free by a magnetic primary drive 22. The primary drive 22 lifts the striker 4 opposite the impact direction 5. As subsequently explained, according to some embodiments, the primary drive 22 is only temporarily activated during the lifting of the striker 4 to the upper reversal point 15. After exceeding the upper reversal point 15, the primary drive 22 accelerates the striker 4 to reach the impact point 14. The primary drive 22 can be activated approximately simultaneous to exceeding the upper reversal point 15. According to some embodiments, the primary drive 22 remains active up to the impact. An air spring 23 aids the primary drive 22 during the movement of the striker 4 in the impact direction 5, starting from the upper reversal point to shortly before the impact point. The air spring 23 is mounted on the movement axis 3 in the impact direction 5 upstream of the striker 4 and affects the striker 4.

The striker 4 includes primarily a cylindrical base body, a lateral surface 24 of which is parallel to the movement axis 3. A front end face 25 points in the impact direction 5. According to some embodiments, the front end face 25 may be relatively smooth and cover the entire cross section of the striker 4. Likewise, according to some embodiments a rear end face 26 may also be relatively smooth. The striker 4 is inserted into a guide tube 27. The guide tube 27 is coaxial to the movement axis 3 and has a cylindrical inner wall 28. The lateral surface 24 of the striker 4 contacts the inner wall 28. The striker 4 is positively driven in the guide tube 27 on the movement axis 3. A cross section of the striker 4 and a hollow cross section of the guide tube 27 are matched to each other up to a tightly fitting low clearance. The striker 4 immediately closes a floating seal of the guide tube 27. A seal ring 29 made of rubber can equalize manufacturing tolerances introduced into the lateral surface 24.

The guide tube 27 is closed at its front end in the impact direction 5. In the exemplary embodiment, a closure 30 is inserted into the guide tube 27, the cross section thereof corresponding to the hollow cross section of the guide tube 27. According to some embodiments, a closure surface 31 facing the interior may be relatively smooth and perpendicular to the movement axis 3. The closure 30 is mounted at a fixed distance 32 to the anvil 13 resting in the home position 16. The hollow chamber between the closure 30 and the anvil 13, in the home position 16, is the effective region of the guide tube 27 for the striker 4, within which the striker 4 can move. The maximum stroke 18 is essentially the distance 32 less the length 33 of the striker 4.

The guide tube 27, closed on one side, and the striker 4 close off a pneumatic chamber 34. A volume of the pneumatic chamber 34 is proportional to a distance 35 between the closure surface 31 and the rear end face 26 of the striker. The volume is variable due to the striker 4 being moveable along the movement axis 3. The function of the air spring 23 arises from the air compressed or decompressed by a movement in the pneumatic chamber 34. The pneumatic chamber 34 occupies the maximum volume at the impact point 14, i.e., when the striker 4 impacts the anvil 13. The pressure in the pneumatic chamber 34 is thus at the lowest and advantageously the same as the ambient pressure. The potential energy of the air spring 23 is by definition equal to zero at the impact point 14. The pneumatic chamber 34 reaches the lowest volume at the upper reversal point 15 of the striker 4. In some embodiments, the pressure of the pneumatic chamber 34 can increase up to approximately 16 bar. The stroke of the striker 4 is limited by a control method in order to set the volume and the pressure of the pneumatic chamber 34 at the upper reversal point 15 to a target value. According to some embodiments, the potential energy of the air spring 23 lies in a narrow range of values at the upper reversal point 15, independent of external influences. By these means, the striking mechanism 2 becomes robust with regard to the position of the anvil 13 during impact, even though the position thereof has a large influence on the duration of movement of the striker 4 up to the upper reversal point 15.

The air spring 23 is provided with one or more ventilation openings 36 to compensate for losses in the amount of air in the air spring 23. The ventilation openings 36 are closed during the compression of the air spring 23 by the striker 4. According to some embodiments, the striker 4 unblocks the ventilation openings 36 shortly before the impact point 14. According to some embodiments, this unblocking of the ventilation openings occurs when the pressure in the air spring 23 differs by less than 50% from the ambient pressure. According to some embodiments, the striker 4 passes over the ventilation openings 36 when the striker has moved more than 5% of the stroke 18 thereof from the impact position.

The primary drive 22 is based on reluctance forces, which affect the striker 4. The base body of the striker 4 is made of magnetically soft steel. In contrast to a permanent magnet, the striker 4 is characterized by the low coercive field strength thereof of less than 4,000 A/m, and more particularly, less than 2,500 A/m. An external magnetic field with this low field strength can already reverse the polarity of a polarization of the striker 4. An externally applied magnetic field pulls the magnetizable striker 4 into regions of the highest field strength, independent of the polarity thereof.

The primary drive 22 has a hollow chamber along the movement axis 3, in which the guide tube 27 is inserted. The primary drive 22 generates a permanent magnetic field 37 and a two-part switchable magnetic field 38 in the hollow chamber and within the guide tube. The magnetic fields 37, 38 divide the hollow chamber and the effective region of the guide tube 27 along the movement axis 3 into an upper section 39, a middle section 40, and a lower section 41. Field lines of the magnetic fields 37, 38 run in the upper section 39 and in the lower section 41 substantially parallel to the movement axis 3, and in the middle section 40 substantially transverse to the movement axis 3. The magnetic fields 37, 38 differ in the parallel or anti-parallel orientation of the field lines thereof to the impact direction 5. The field lines (dash-dot lines) of the permanent magnetic field 37 shown in part by means of example run substantially anti-parallel to the impact direction 5 in the upper section 39 of the guide tube 27 and substantially parallel to the impact direction 5 in a lower section 41 of the guide tube 27. The different direction of movement of the field lines of the permanent magnetic field 37 in the upper section 39, as compared to the direction of movement in the lower section 41, ensures proper function of the striking mechanism 2. The field lines of the switchable magnetic field 38 run, during one phase (shown as dashed lines), substantially in the impact direction 5 within the upper section 39 and lower section 41 of the guide tube 27, and during another phase (not shown), substantially antiparallel to the impact direction 5 within both sections 39, 41. The permanent magnetic field 37 and the switchable magnetic field 38 thus superpose one another destructively in one of the two sections 39 and constructively in the other of the section 41. In which of the section 39 the magnetic fields 37, 38 constructively superpose depends on the current switching cycle of the controller 12. The striker 4 is pulled into the sections 39, 41 respectively by constructive superposition. An alternating change of polarity of the switchable magnetic field 38 drives the back and forth movement of the striker 4.

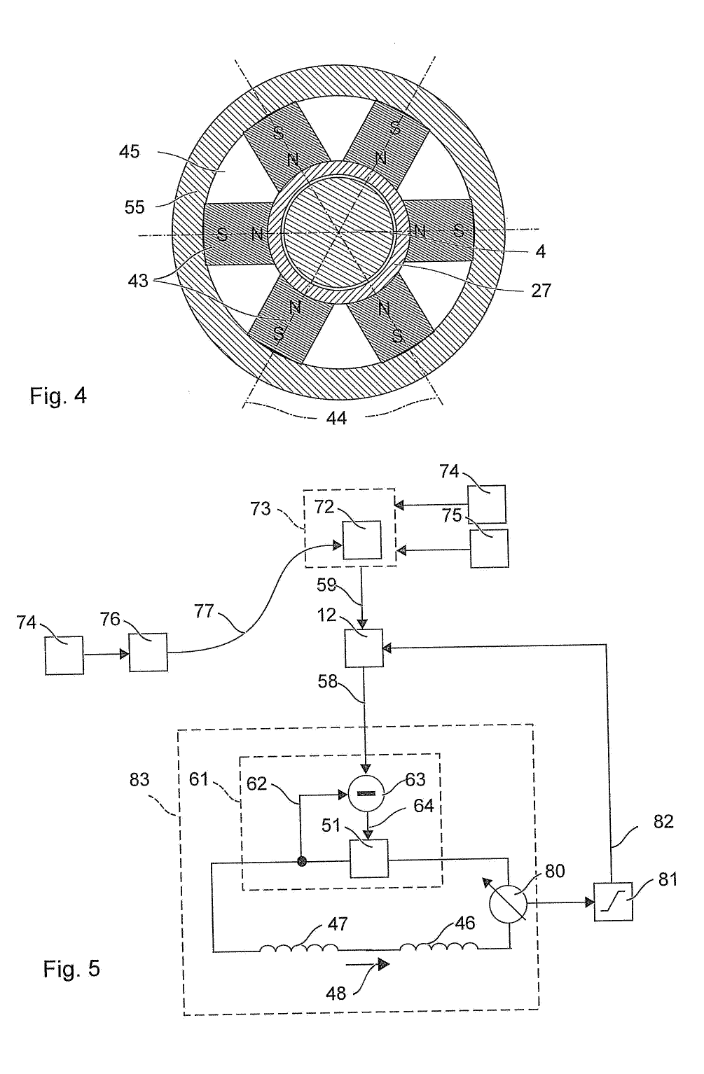

The permanent magnetic field 37 is generated by a radially magnetized annular magnet 42 made of a plurality of permanent magnets 43. FIG. 4 shows the annular magnet 42 in a cut away view along plane IV-IV. The permanent magnets 43 may, for example, be bar magnets. The permanent magnets 43 are oriented in the radial direction. A magnetic field axes 44 thereof, i.e. from the south pole to the north pole thereof, is perpendicular to the movement axis 3. The permanent magnets 43 are all oriented identically, in the example shown, the north pole N points at the movement axis 3 and the south pole S points away from the movement axis 3. An air gap or a non-magnetizable material 45, e.g., plastic, can be in the circumferential direction between the permanent magnets 43. The annular magnet 42 is arranged along the movement axis 3 between the closure surface 31 and the anvil 13. According to some embodiments, the annular magnet 42 is asymmetrically arranged, in particular closer to the closure surface 31 than to the anvil 13. The position of the annular magnet 42 divides the guide tube 27 along the movement axis 3 into an upper section 39, which is upstream of the annular magnet 42 in the impact direction 5, and a lower section 41, which is downstream of the annular magnet 42 in the impact direction 5. The field lines run substantially in the opposing direction in the upper section 39 in comparison to the field lines in the lower section 41. According to some embodiments, the permanent magnets 43 contain an alloy made of neodymium. According to some embodiments, the field strength at the poles of the permanent magnets 43 lies above 1 tesla, e.g., up to 2 tesla.

The switchable magnetic field 38 is generated using an upper magnetic coil 46 and a lower magnetic coil 47. The upper magnetic coil 46 is arranged upstream of the annular magnet 42 in the impact direction 5. According to some embodiments, the upper magnetic coil 46 directly contacts the annular magnet 42. The upper magnetic coil 46 encompasses the upper section 39 of the guide tube 27. The lower magnetic coil 47 is arranged downstream of the annular magnet 42 in the impact direction 5 and encompasses the lower section 41. According to some embodiments, the lower magnetic coil 47 directly contacts the annular magnet 42. The two magnetic coils 46, 47 are flowed through by a current 48 in the same circulating direction around the movement axis 3. An upper magnetic field 49 generated by the upper magnetic coil 46 and a lower magnetic field 50 generated by the magnetic coil 47 are substantially parallel to the movement axis 3 and both are oriented in the same direction along the movement axis 3, i.e., the field lines of both magnetic fields 49, 50 run inside of the guide tube 27 either in the impact direction 5 or opposite the impact direction 5. The current 48 is supplied by a controllable power source 51 into the magnetic coils 46, 47. In some embodiments, the two magnetic coils 46, 47 and the power source 51 are connected in series (see, e.g., FIG. 5).

According to some embodiments, a length 52, i.e., a measurement along the movement axis 3 of the lower magnetic coil 47, is greater than the length 53 of the upper magnetic coil 46. In some embodiments, the length ratio lies in the range between 1.75:1 and 2.25:1. In some embodiments, the respective absolute values of the magnetic coils 46, 47 to the field strength of the upper magnetic field 49 and/or to the field strength of the lower magnetic field 50 are identical within the guide tube 27. In some embodiments, the ratio of the winding count of the upper magnetic coil 46 to the winding count of the lower magnetic coil 47 can correspond to the length ratio. In some embodiments, radial dimensions 54 and a current areal density may be identical for the two magnetic coils 46, 47 (without the other components of the striking mechanism).

A magnetic yoke 55 can conduct the magnetic fields 37, 38 outside of the guide tube 27. The yoke 55 has, for example, a hollow cylinder or a cage made of a plurality of ribs running along the movement axis 3, which encompasses the two magnetic coils 46, 47 and the annular magnet 42 made of permanent magnets 43. An annular upper end 56 of the yoke 55 covers the upper magnetic coil 46 opposite the impact direction 5. An annular lower end 57 borders the height of the anvil 13 at the guide tube 27. The lower end 57 covers the lower magnetic coil 47 in the impact direction 5. The magnetic fields 37, 38 are guided parallel or antiparallel to the movement axis 3 in the upper section 39 and the lower section 41. The magnetic fields 37, 38 of the yoke 55, in particular the annular ends 56, 57, are supplied in the radial direction. A radial feedback occurs in the lower section 41 substantially within the anvil 13. Thus, in some embodiments, the field lines stand substantially perpendicular to the end face 26 of the striker 4 and the impact surface 58 of the anvil 13. The radial feedback in the upper section 39 can take place unguided, i.e. above the air in the yoke 55.

The magnetic yoke 55 is made of a magnetizable material. In some embodiments, the magnetic yoke 55 is made from magnetic steel sheets. Conversely, the guide tube 27 is not magnetizable. Suitable materials for the guide tube 27 include chromium steel, alternately aluminum or plastic. In some embodiments, the closure 30 of the guide tube 27 is made of a non-magnetizable material.

In some embodiments, the striker 4 overlaps in each position thereof with both magnetic coils 46, 47. In particular, the rear end face 26 projects into the upper magnetic coil 46 or at least up into the annular magnet 42 when the striker 4 contacts the anvil 13. The rear end face 26 projects above at least the axial middle of the annular magnet 42. The ventilation opening 36 of the pneumatic chamber 34 is arranged at the axial height of one of the ends of the upper magnetic coil 46 facing the annular magnet 42. The distance 35 to the annular magnet 42 may, for example, be on the order of less than 1 cm.

A controller 12 of the striking mechanism 2 controls the power source 51. The power source 51 sets the current 48 output therefrom to a target value 60 predetermined by the controller 12 by means of a control signal 59. According to some embodiments, the power source 51 contains a control circuit 61 to stabilize the output current 48 to the target value 60. A tap measures the actual current 62. A difference amplifier 63 formulates a control variable 64 from the actual current 48 and the target value 60, which control variable is supplied to the power source 51 to control the current delivery. The power source 51 is supplied by a power supply 65, for example a main connection or a battery pack.

The controller 12 switches the target value 60 and indirectly the current 48 during a back and forth movement of the striker 4. FIG. 6 illustrates an example of the repeating switching pattern over time 19. The switching pattern is essentially divided into three different phases. A cycle begins with an active retraction phase 66. During the active retraction phase 66, the striker 4 is accelerated, starting from the impact position, opposite the impact direction 5. The active retraction phase 66 ends when the air spring 23 has achieved a predetermined potential energy. A resting phase 67 directly follows the active retraction phase 66. The resting phase ends when the striker 4 reaches the upper reversal point 15. An acceleration phase 68 begins when or after the striker 4 exceeds the upper reversal point 15. During the acceleration phase 68, the striker 4 is accelerated in the impact direction 5. In some embodiments, the striker 4 is accelerated during the acceleration phase 68 until the striker 4 impacts on the anvil 13. According to the desired impact frequency, a break 69 can follow the acceleration phase 68 before the next active retraction phase 66 begins.

The controller 12 initiates a new impact with an active retraction phase 66. The controller 12 specifies a first value 70 as the target value 60 to the controlled energy source 51. The plus/minus sign (polarity) of the first value 70 determines that the current 48 circulates in the magnetic coil 47 in such a way that the magnetic field 49 of the upper magnetic coil 46 constructively superposes with the permanent magnetic field 37 in the upper section 39 of the guide tube 27. The striker 4 is now accelerated into the upper section 39 opposite the impact direction 5 and opposite a force of the air spring 23. As this occurs, the kinetic energy of the striker 4 continually increases. Due to the reverse movement, the air spring 23 is simultaneously compressed and the potential energy stored therein increases based on the volume work performed.

According to some embodiments, the current 48 runs through both magnetic coils 46, 47. In some embodiments, the magnetic fields 37, 38 superpose destructively in the lower section 41. The amount of the first value 70 can be selected in such a way that the magnetic field 50 generated by the lower magnetic coil 47 destructively compensates for the permanent magnetic field 37 of the permanent magnets 43. In some embodiments, the magnetic field strength in the lower section 41 is reduced, for example, to zero or to less than 10% of the magnetic field strength in the upper section 39. The power source 51 and the magnetic coils 46, 47 are designed for the current 48 with the current strength of the first value 70. The first value 70 can be constantly maintained during the active retraction phase 66.

The controller 12 triggers the end of the active retraction phase 66 based on a prognosis about the potential energy of the air spring 23 in the upper reversal point 15. The primary drive 22 is, for example, deactivated when the potential energy will reach a target value without further aid from the primary drive 22. This takes into account that at the point in time 71 of the switching off of the primary drive 22, the potential energy has already achieved a part of the target value and the current kinetic energy of the striker 4 is converted into the previously missing part of the target value up to the upper reversal point 15. Losses during the conversion can be factored in by a table 72 stored in the controller 12. According to some embodiments, the target value may lie in the range between 25% and 40%, e.g., at least 30% and, e.g., at most 37%, of the impact energy of the striker 4.

A prognosis means 73 constantly compares the operating conditions of the striking mechanism 2. An exemplary prognosis is based on a pressure measurement. The prognosis means 73 taps the signals from a pressure sensor 74. The pressure measured is compared with a threshold value. If the pressure exceeds the threshold value, the prognosis means 73 outputs a control signal 59 to the controller 12. The control signal 59 signals that, upon immediate switching off of the primary drive 22, the potential energy will reach the target value. The controller 12 ends the active retraction phase 66.

The prognosis means 73 loads the threshold value, e.g., from the stored reference table 72. In some embodiments, the reference table 72 can contain exactly one threshold value. In other embodiments, however, several previously determined threshold values are stored for different operating conditions. For example, threshold values can be stored for different temperatures in the pneumatic chamber 34. The prognosis means 73 also records a signal from a temperature sensor 75 in addition to the signal from the pressure sensor 74. Depending on the former, for example, the threshold value is selected.

In addition, the prognosis means 73 can estimate the velocity of the striker 4 from a pressure change. The reference table 72 can contain different threshold values for the current pressure for different velocities. Since a faster striker 4 tends to compress the air spring 23 more strongly, the threshold value is lower for a higher velocity than for a lower velocity. The selection of the threshold value as a function of the velocity or of the pressure change can improve the reproducibility of the target value.

The end of the active retraction phase 66 is simultaneously the beginning of the resting phase 67. The controller 12 sets the target value 60 for the current 48 to zero. The switchable magnetic field 38 is switched off and the primary drive 22 is deactivated. The permanent magnetic field 37 still affects the striker 4. However, since the permanent magnetic field 37 has an essentially constant field strength along the movement axis 3, it exerts only a small force or no force on the striker 4.

Instead of reducing the current 48 to zero, the current 48 in the resting phase 67 can be set at a negative value to the target value 60. The amount of the current 48 may be relatively low compared to the target value 60 in order not to interfere with the reverse movement, e.g., lower than 10%.

During the resting phase 67, the striker 4 is braked to a stop by the air spring 23. The potential energy of the air spring 23 thereby increases by a part of the kinetic energy of the striker 4 before the striker 4 arrives at a stop, i.e. arrives at the upper reversal point 15.

The sequence of the active retraction phase 66 and the resting phase 67 has proven to be especially energy efficient with regard to the tested designs of the striking mechanism, in particular the switching off of the current 48 to zero at the end of the active retraction phase 66. The efficiency of the primary drive 22 drops at a decreasing distance 35 of the striker 4 to the upper reversal point 15. The striker 4 is accelerated at a high velocity as long as the primary drive 22 functions efficiently. If the prognosis shows that the striker 4 will now reach the desired upper reversal point 15 without the primary drive 22, the increasingly inefficiently functioning primary drive 22 is deactivated. As an alternative, the current 48 is reduced to zero continuously or over several stages. By these means, an adaptive adjustment of the flight path of the striker 4 for reaching the upper reversal point 15 can be carried out at a cost to the efficiency. Even in the alternative, the resting phase 67 can switch on before reaching the upper reversal point 15.

The duration of the active retraction phase 66 arises from the prognosis. The duration can be of differing lengths depending on operation or even from impact to impact. For example, if the anvil 13 does not reach the home position 16 thereof before an impact, this means that the striker 4 must cover a longer path for the next impact. At a fixed duration of the active acceleration phase 66, the kinetic energy absorbed for the striker 4 would not suffice against the force of the air spring 23 up to the desired upper reversal point 15.

The controller 12 triggers the end of the resting phase 67 based on reaching the upper reversal point 15. At the end of the resting phase 67, the acceleration phase 68 begins. The controller 12 triggers the beginning of the acceleration phase 68 based on the reversal movement of the striker 4. A position or movement sensor can directly detect the reversal movement of the striker 4. According to some embodiments, the detection of the reversal movement rests indirectly on a pressure change in the pneumatic chamber 34.

A pressure sensor 74 is coupled to the pneumatic chamber 34. The pressure sensor 74 may, for example, be a piezoresistive pressure sensor 74. The pressure sensor 74 can be arranged in the pneumatic chamber 34 or be coupled to the pneumatic chamber 34 via an air channel. In some embodiments, the pressure sensor 74 is arranged on or in the closure 30. An evaluation device 76 is assigned to the pressure sensor 74. The evaluation device 76 monitors a pressure change in the pneumatic chamber 34. As soon as the pressure change takes on a negative value, i.e. the pressure falls, the evaluation device 76 outputs a control signal 77 to the controller 12 which indicates the reaching of the upper reversal point 15 by the striker 4.

The evaluation of the pressure change leads, depending on the method, to a slight delay until the detection of the upper reversal point 15 has been reached, more exactly exceeded. The pressure can also be absolutely determined and compared with a threshold value. If the pressure reaches the threshold value, the output of the control signal 77 is triggered. The pressure in the pneumatic chamber 34 can be measured at the upper reversal point 15 and stored as the threshold value in a table in the evaluation unit 76. The threshold value can be stored as a function of different operating conditions, in particular as a function of a temperature in the pneumatic chamber 34. The evaluation unit 76 detects the present operating condition, for example by querying a temperature sensor, and reads the associated threshold value from the table. The two methods can be redundantly combined and can output the control signal 77 separately from each other.

The controller 12 begins the acceleration phase 68 when the control signal 77 is received. The controller 12 sets the target value 60 for the current 48 to a second value 78. The plus/minus sign of the second value 78 is selected such that the lower magnetic field 50 of the lower magnetic coil 47 constructively superposes the permanent magnetic field 37 inside of the guide tube 27. A high field strength thus results in the lower section 41 of the guide tube 27. In some embodiments, the current 48 is supplied during the acceleration phase 68 into the lower magnetic coil 47 and into the upper magnetic coil 46. In some embodiments, the permanent magnetic field 37 in the upper section 39 is dampened or completely deconstructively compensated by the magnetic field 38 of the upper magnetic coil 46 inside of the guide tube 27. The striker 4 is pulled into the stronger magnetic field in the lower section 41. The striker 4 constantly undergoes acceleration in the impact direction 5 during the acceleration phase 68. The kinetic energy achieved up to the impact point 14 is approximately the impact energy of the striker 4.

An alternative or additional determination of reaching the upper reversal point 15 is based on a change of the voltage induced in the upper magnetic coil 46 due to the movement of the striker 4. The striker 4 can already, before reaching the upper reversal point 15, overlap with the upper annular end 56 of the yoke ring 55. The magnetic field 49 of the annular magnet 42 flows in the upper section 39 practically closed without an air gap into the upper yoke ring 56 via the striker 4. The magnetic field 50 of the annular magnet 42 flows in the lower region 41 to the lower annular end 57 of the yoke ring 57 via a relatively large air gap. During the movement of the striker 4 up to the reversal point 15, the air gap in the lower region 41 increases still further, by which means the magnetic flow in the lower region increases proportionally. As soon as the striker 4 reverses at the reversal point 15, the proportion of the magnetic flow in the upper section 39 decreases. The change of the magnetic flow induces a voltage in the upper magnetic coil 46. A change of the plus/minus sign of the induced voltage is characteristic for the reversal point 15. In some embodiments, the power source 51 regulates the current 48 to zero prior to reaching the reversal point 15, in order to maintain the resting phase 67. The control loop constantly adapts the control variable 64 in order to hold the current 48 at zero against the induced voltage. At the change of the plus/minus sign of the induced voltage, the control loop reacts with a significantly larger control variable 64. The control signal 77 can thus, for example, be triggered upon the control variable 64 exceeding a threshold value.

According to some embodiments, the amount of the second value 78 is determined so that the upper magnetic field 49 destructively compensates exactly for the permanent magnetic field 37 or reduces the field strength thereof to at least 10%. The current 48 in the magnetic coils 46, 47 increases at the beginning of the acceleration phase 68 to a target value 60. A rising edge is, for example, only predetermined by a time constant, which arises due to the inductivity of the magnetic coils 46, 47 and the reaction of the striker 4. In some embodiments, the controller 12 holds the target value 60 constant at the second value 78 during the acceleration phase 68.

The air spring 23 aids the acceleration of the striker 4 in the impact direction 5. Thereby, potential energy stored in the air spring 23 is substantially transformed into kinetic energy of the striker 4. According to some embodiments, the air spring 23 is completely released at the impact point 14. Close to the impact point 14, the ventilation opening 36 is unblocked by the striker 4. The ventilation opening 36 leads to a weakening of the air spring 23 without reducing the effect thereof on the striker 4 completely to zero. The air spring 23 has, however, at this point in time transferred significantly more than 90% of the potential energy thereof to the striker 4.

The controller 12 triggers the end of the acceleration phase 68 based on an increase 79 of the current 48 in the lower magnetic coil 47 and/or of the current 48 supplied by the power source 51. While the striker 4 moves, a voltage drop occurs due to the electromagnetic induction via the lower magnetic coil 47, against which voltage drop the power source 51 supplies the current 48. At the impact and the standing striker 4, the voltage drop abruptly disappears. The current 48 increases for a short time until the regulated power source 51 regulates the current 48 to the target value 60 again.

A current sensor 80 can detect the current 48 circulating in the lower magnetic coil 47. An associated discriminator 81 compares the measured current 48 with a threshold value and outputs an end signal 82 upon exceeding the threshold value. The end signal 82 indicates to the controller 12 that the striker 4 has impacted the anvil 13. The threshold value is, for example, selected as a function of the second value 78, i.e., the target value 60 for the acceleration phase 68. The threshold value can be 5% to 10% greater than the second value 78. Alternatively or in addition to a detection of the absolute current 48, a rate of change of the current 48 can be detected using a current sensor 80 and compared, using the discriminator 81, to a threshold value for the rate of change.

The power source 51 counteracts the increase 79 of the current 48 in the circuit 83 using the power source control circuit 61. The control variable 64 changes thereby. Instead of or in addition to a change of the current 48, the control variable 64 can also be monitored. In some embodiments, the absolute value or a rate of change of the control variable 64 can be compared to a threshold value and the end signal 82 can be accordingly output.

Upon receiving the end signal 82, the controller 12 ends the acceleration phase 68. The target value 60 is set to zero. The current output of the power source 51 is correspondingly reduced to a current 48 equal to zero. The striker 4 is no longer accelerated in the impact direction 5.

The controller 12 can begin the next active retraction phase 66 directly subsequent to the acceleration phase 68 or following a break.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A control method for a machine tool, the machine tool comprising a tool holder equipped to mount a tool moveably along a movement axis and a striking mechanism, the striking mechanism comprising a primary drive, a striker, an anvil and an air spring, the primary drive being arranged around the movement axis and comprising, in sequence in an impact direction, a first magnetic coil, a permanent and radially magnetized annular magnet, and a second magnetic coil, the striker and anvil movable within the magnetic coils on the movement axis in sequence in an impact direction, and the air spring affecting the striker in the impact direction, the control method comprising:
an active retraction phase during which the striker is accelerated opposite the impact direction by the primary drive until a kinetic energy of the striker is sufficient to achieve a selected compression of the air spring as a function of the impact energy of the striker.

2. A control method according to claim 1, further comprising a resting phase following the active retraction phase up until achieving the selected compression of the air spring, the primary drive being deactivated during the resting phase.

3. A control method according to claim 2, wherein the duration of the resting phase is at least 10% of the duration of the active retraction phase.

4. A control method according to claim 1, wherein a potential energy of the air spring at the selected compression corresponds to between 25% and 40% of the impact energy of the striker.

5. A control method according to claim 1, further comprising, during the activation phase, determining an achievable compression of the air spring without assistance from the primary drive.

6. A control method according to claim 5, further comprising determining the achievable compression of the air spring as a function of a pressure in the air spring.

7. A control method according to claim 5, further comprising determining the achievable compression of the air spring as a function of a velocity of the striker.

8. A control method according to claim 7, further comprising determining the velocity of the striker as a function of a gradient of the pressure in air spring.

9. A control method according to claim 5, further comprising determining an achievable compression on the basis of a measurement of the current pressure in the air spring and/or a measurement of a current velocity of a the striker.

10. A control method according to claim 2, wherein during the active retraction phase, a first magnetic field generated inside of the first magnetic coil by the first magnetic coil is constructively superposed with the magnetic field of the annular magnet and a second magnetic field generated inside of the second magnetic coil by the second magnetic coil is destructively superposed with the magnetic field of the annular magnet and, during the resting phase, the first magnetic coil and the second magnetic coil do not generate a magnetic field.

11. A control method according to claim 10, further comprising, supplying a current in the same circumferential direction into the first magnetic coil and into the second magnetic coil during the activation phase, and stopping the supply of current to the magnetic coils during the resting phase.

12. A control method according to claim 2, further comprising monitoring a pressure in the air spring during the resting phase and upon detecting a drop in the pressure, initiating an acceleration phase in which the primary drive accelerates the striker in the impact direction.

13. A control method according to claim 12, wherein a first magnetic field generated inside of the first magnetic coil by the first magnetic coil is destructively superposed with the magnetic field of the annular magnet during the acceleration phase and a second magnetic field generated inside of the second magnetic coil by the second magnetic coil is constructively superposed with the magnetic field of the annular magnet during the acceleration phase.

14. A control method for a machine tool, the machine tool comprising a tool holder equipped to mount a tool moveably along a movement axis and a striking mechanism, the striking mechanism comprising a primary drive, a striker, an anvil and an air spring, the primary drive being arranged around the movement axis and comprising, in sequence in an impact direction, a first magnetic coil, a permanent and radially magnetized annular magnet, and a second magnetic coil, the striker and an anvil movable within the magnetic coils on the movement axis in sequence in the impact direction, and the air spring affecting the striker in the impact direction, the control method comprising the steps of:
activating the primary drive during an active retraction phase to accelerate the striker opposite the impact direction until a kinetic energy of the striker is sufficient to achieve a selected compression of the air spring as a function of the impact energy of the striker;
deactivating the primary drive during a resting phase, following the active retraction phase up until achieving the selected compression of the air spring; and
activating the primary drive following the resting phase to accelerate the striker in the impact direction.

15. The control method of claim 14, further comprising monitoring a pressure in the air spring during the resting phase and initiating the acceleration phase upon detecting a selected pressure drop in the pressure.

16. A control method according to one of claim 15, further comprising determining an achievable compression of the air spring on the basis of a measurement of a current pressure in the air spring and/or a measurement of a current velocity of a the striker.

17. A machine tool, comprising:
a tool holder equipped to mount a tool moveably along a movement axis;
a magnetic-pneumatic striking mechanism comprising a primary drive, a striker, an anvil and an air spring, the primary drive being arranged around the movement axis and comprising, in sequence in an impact direction, a first magnetic coil, a permanent and radially magnetized annular magnet, and a second magnetic coil, the air spring, striker and anvil arranged within the magnetic coils on the movement axis in sequence in the impact direction, the striker and anvil being moveable within the magnetic coils; and
a controller configured to activate the primary drive during an active retraction phase to accelerate the striker opposite the impact direction until a kinetic energy of the striker is sufficient to achieve a selected compression of the air spring as a function of the impact energy of the striker.

18. A machine tool according to claim 17, wherein the controller is further configured to deactivate the primary drive during a resting phase following the active retraction phase up until achieving the selected compression of the air spring.

19. A machine tool according to claim 18, wherein the controller is further configured to activate the primary drive following the resting phase to accelerate the striker in the impact direction.

20. A machine tool as set forth in claim 17, wherein the tool holder is equipped to mount a chiseling tool.
